(19) United States
(12) Patent Application Publication
(10) Pub. No.: US 2010/0326287 A1
(43) Pub. Date: Dec. 30, 2010

(54) ENERGY SAVING APPARATUS OF GRILLING DEVICE

(75) Inventor: Yaoqing CHEN, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Eujian Province (CN)

(21) Appl. No.: 12/825,469

(22) Filed: Jun. 29, 2010

(30) Foreign Application Priority Data
Jun. 30, 2009 (CN) 200920139332.2

(51) Int. Cl. A47J 37/06

(52) U.S. Cl. 99/331

(57) ABSTRACT

The present invention relates to an energy saving apparatus of grilling device, comprising an upper grilling plate\a lower grilling plate\an upper electric heating tube disposed on the upper grilling plate and a lower electric heating tube disposed on the lower grilling plate, a control switch series connected on the upper electric heating tube. Compared to the conventional technique, the energy saving apparatus of grilling device of the present invention applies a control switch series connected to the upper electric heating tube, the upper electric heating tube will be automatically disconnected when the upper grilling plate is opened.

### FIELD OF THE INVENTIOn

The present invention relates to the field of grilling device, especially to an energy saving apparatus of grilling device.

### BACKGROUND OF THE INVENTION

The conventional grilling device usually has upper and lower grilling plates, it usually start the upper and lower grilling plates simultaneously to heat the food, when the upper grilling plate is started, although the upper grilling device does not heat the food, it is kept power-on, so the energy is wasted and it goes against the concept of energy saving and environmental protection.

### SUMMARY OF THE INVENTION

The main objective of the present invention is to overcome the shortages of the conventional technique, wherein the upper grilling plate of grilling device with upper and lower grilling plates is kept power-on for heating, it provides an energy saving apparatus of grilling device, the electric heating tube of upper grilling plate will be automatically power-off after the upper grilling plate is started.

The technical solution applied by the present invention is:

An energy saving apparatus of grilling device, comprising an upper grilling plate, a lower grilling plate, an upper electric heating tube disposed on the upper grilling plate and an lower electric heating tube disposed on the lower grilling plate, a control switch is series connected to said upper electric heating tube.

Said control switch is electrically connected to said upper electric heating tube.

Further, said control switch comprises a housing\a movable contact piece and a static contact piece, a steel ball disposed inside said housing, a cone-shaped slot disposed on the bottom of said housing; wherein the bottom of said cone-shaped slot has a through hole, and said movable contact piece leans against in said through hole.

When operates the energy saving apparatus of grilling device of present invention, and when the upper and lower grilling plates are completely covered together, the steel ball of control switch falls into the cone-shaped slot of the bottom of the housing, the movable contact piece will be leaned to contact the contacting point of the static contact piece, so the control switch will be conducted, the electric heating tube of upper grilling plate will be conducted to heat the food when the it is power-on; after the upper grilling plate is started, the steel ball will roll out of the tank bottom of the cone-shaped slot, the movable contact piece will separate from the static contact piece by its own elasticity, then the control switch and the electric heating tube of upper grilling plate will be power-off, the food will be heated no longer.

Referred from the above description of the present invention, compared to the conventional technique, the energy saving apparatus of grilling device of the present invention applies a control switch series connected to the electric heating tube of the upper grilling plate, the electric heating tube of upper grilling plate will be automatically power-off at great ease after the upper grilling plate is started, the structure is simple, the cost assembly will not be increased basically, it only needs to add a control switch, then the purpose of energy saving and environmental protection is achieved, it is widely used in grilling device which has upper and lower grilling plates, its market prospect is broad.

### BRIEF DESCRIPTION OF THE DRAWINGS

FIG. 1 is the electrical circuit diagram of the present invention.

FIG. 2 is the sectional structural view of the preferred embodiment of the present invention when the control switch is power-on.

FIG. 3 is the sectional structural view of the preferred embodiment of the present invention when the control switch is power-off.

FIG. 4 is the structural view of the present invention when the control switch is mounted on a position of upper grilling plate.

FIG. 5 is the structural view of the present invention when the control switch is mounted on another position of upper grilling plate.

### DETAILED DESCRIPTION OF THE EMBODIMENTS

The present invention will become apparent with the reference of the description of the preferred embodiments, what should be claimed is, although the present invention has described the structure of the control switch, the structure of the control switch is not limited by the description of the present invention, it is arranged just for easily describing, any control switch of appropriate structure are suitable in the energy saving apparatus of the grilling device of the present invention.

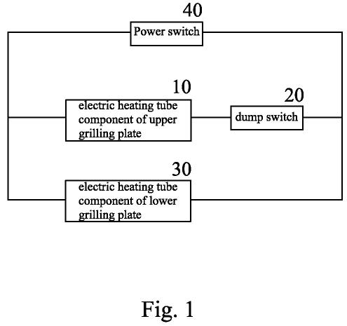

Please refer to FIG. 1, the energy saving apparatus of the grilling device of the present invention, comprising an upper grilling plate\a lower grilling plate\an electric heating tube 10 of upper grilling plate disposed on the upper grilling plate and an electric heating tube 30 of lower grilling plated disposed on the lower grilling plate, a control switch 20 is series connected to the electric heating tube 10 of upper grilling plate, after the series connection, then the electric heating tube 10 of upper grilling plate is parallel connected to the electric heating tube 30 of lower grilling plate, then connected to the power switch 40 of grilling device.

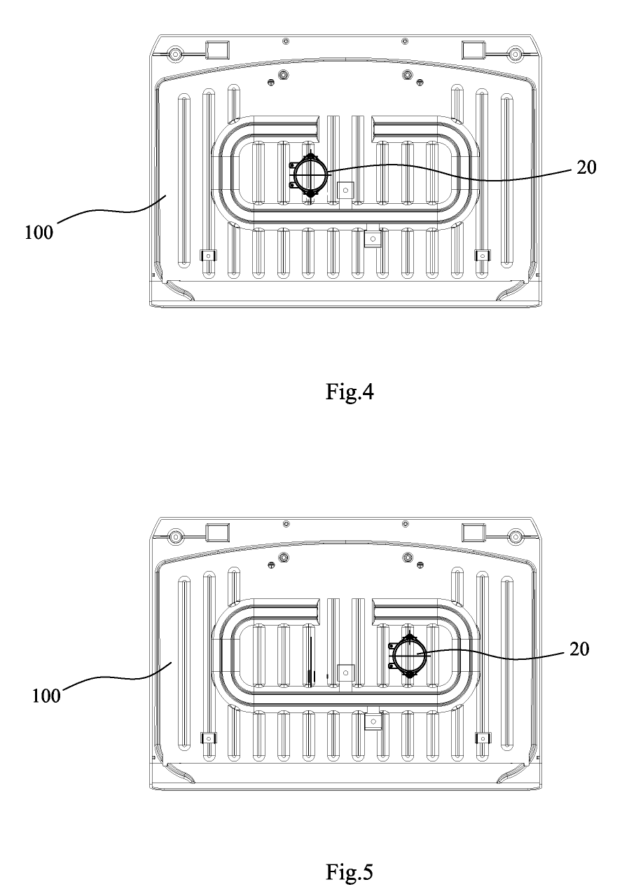

The control switch 20 can be mounted on optional position of the upper grilling plate 100, and electrically connected to the electric heating tube 10 of upper grilling plate, please refer to FIG. 4 and FIG. 5, they respectively illustrate the structural views of the control switch mounted on the two positions of the upper grilling plate 100.

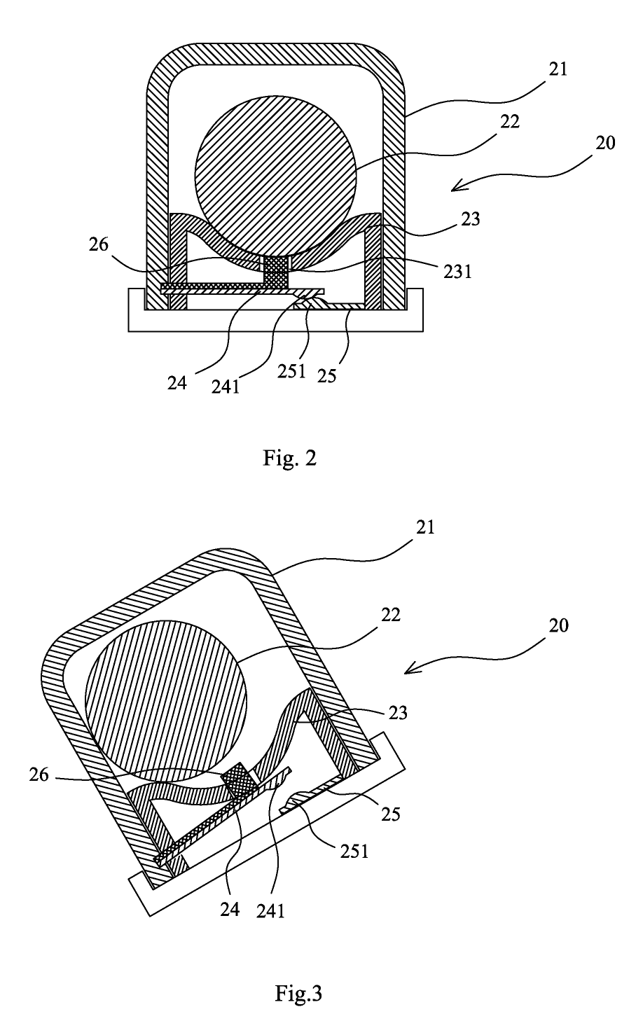

Please refer to FIG. 2 and FIG. 3, control switch 20 comprises a housing 21\a movable contact piece 24 and a static contact piece 25, a steel ball 22 is disposed inside of said housing 21, a cone-shaped slot 23 is disposed on the bottom of said housing 21, the tank bottom of cone-shaped slot 23 has a through hole 231. The movable contact piece 24 has a leaning member 26 which extends into the through hole 231. The movable contact piece 24 and static contact piece 25 are respectively disposed with adaptable contacting points 241\251.

When the energy saving apparatus of grilling device of the present invention is under use, and when the upper and lower grilling plates are completely covered, the steel ball 22 of control switch 20 falls into the cone-shaped slot 23 of the bottom of the housing 21, the leaning member 26 is leaned to cause the movable contact piece to be pressed down, then the contacting point 241 of movable contact piece 24 will contact the contacting point 251 of static contact piece 25, then the control switch 20 is switched on, then the electric heating tube 10 of upper grilling plate will be conducted to heat the food when the power switch 40 is switched on; when the upper grilling plate is started, the steel ball 22 will roll out of the tank bottom of the cone-shaped slot 23, the steel ball 22 will not lean against the leaning member 26, the contacting point 241 of movable contact piece 24 will separate from the contacting point 251 of static contact piece 25, the control switch will be power-off, that is the electric heating tube 10 of upper grilling plate is disconnected, so the food will be heated no longer.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What is claimed is:

1. An energy saving apparatus of grilling device, comprising an upper grilling plate, a lower grilling plate, an upper electric heating tube disposed on the upper grilling plate and a lower electric heating tube disposed on the lower grilling plate, characterizes in that a control switch is series connected to said upper electric heating tube.

2. The energy saving apparatus of grilling device according to claim 1, characterizes in that said control switch is electrically connected to said upper electric heating tube.

3. The energy saving apparatus of grilling device according to claim 1, characterizes in that said control switch comprises a housing\a movable contact piece and a static contact piece, a steel ball disposed inside said housing, a cone-shaped slot disposed on the bottom of said housing; wherein the bottom of said cone-shaped slot has a through hole, and said movable contact piece leans against in said through hole.
